(19) United States
(12) Patent Application Publication
(10) Pub. No.: US 2003/0027543 A1
(43) Pub. Date: Feb. 6, 2003

(54) Direct conversion receiver

(75) Inventor: Tetsuya Takaki, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/205,366

(22) Filed: Jul. 26, 2002

(30) Foreign Application Priority Data
Aug. 1, 2001 (JP) 232991/2001

(51) Int. Cl. H04B 1/26

(52) U.S. Cl. 455/324; 455/318

(57) ABSTRACT

A direct conversion receiver which amplifies a high-frequency reception signal from an antenna by using an amplifier and converts the signal into a baseband signal by using a mixer comprises an attenuator provided on the input stage of the mixer, and a control device for comparing an antenna reception power with a first threshold and controlling the attenuation amount of the attenuator on the basis of an comparison result. The control device comprises a switching control section for comparing the antenna reception power with the first threshold and controlling switching between a route through the attenuator and the route through the amplifier on the basis of the comparison result.

### BACKGROUND OF THE INVENTION

1. Field of the Invention

The present invention relates to a direct conversion receiver and, more -particularly, to suppression of the power of a secondary emission signal in a direct conversion receiver and prevention of sensitivity drop due to saturation of a frequency converter as a part of the direct conversion receiver.

2. Description of the Related Art

Conventionally, as a receiver used for radio communication, a receiver based on the single conversion scheme is known, which frequency-converts the frequency of a reception signal into a frequency in the intermediate frequency band by using a local oscillation signal having a frequency different from that of the reception signal, performs quadrature demodulation of the reception signal in the intermediate frequency band, and frequency-converts the frequency of the reception into a frequency in the baseband. A receiver using such a single conversion scheme requires a frequency converter for frequency converting a reception signal in the radio band into a reception signal in the intermediate frequency band, a bandpass filter for passing only the reception signal in the intermediate frequency band, and a plurality of oscillators for frequency conversion. This imposes limitations on this receiver in terms of reductions of size and weight.

In contrast to this, a receiver using the direct conversion scheme has recently been in the limelight in terms of reductions in size and weight. This receiver performs quadrature demodulation of a reception signal by using a local oscillation signal having the same frequency as that of the reception signal, and directly frequency-converts the reception signal into a reception signal in the baseband.

In such a receiver using the direct conversion scheme, however, since the frequency of a reception signal is the same as that of a local oscillation signal, part of the power of the local oscillation signal input to the frequency converter mixes in and is emitted from the antenna. This problem is known as secondary emission. The following is an explanation of this problem. In a receiver using the signal conversion scheme, since the frequency of a reception signal differs from that of a local oscillation signal, a mixed local oscillation signal can be removed by using a bandpass filter for passing only the reception signal which is provided between stages in the receiver. In a receiver using the direct conversion scheme, however, since the frequency of a reception signal is the same as that of a local oscillation signal, a mixed local oscillation signal cannot be removed by using a bandpass filter provided between stages in the receiver.

As a method of solving this problem, the technique disclosed in Japanese Patent Laid-Open No. 11-46153 is available. The operation of the receiver disclosed in Japanese Patent Laid-Open No. 11-46153 will be described with reference to FIG. 1. The receiver disclosed in this reference is comprised of an antenna 301, an LNA 302 serving as a low-noise amplifier, a multiplier 303, mixers 304 and 305, a phase shifter 306, a local oscillator 307, baseband amplifiers 308 and 309, low-pass filters 310 and 311, a phase detector 312, and a voice amplifier 313. The respective constituent elements are connected as shown in FIG. 1.

Referring to FIG. 1, the reception signal received by the antenna 301 is amplified by the LNA 302 and multiplied by n by the multiplier 303. The reception signal whose frequency is multiplied by n by the multiplier 303 is quadrature-demodulated by the mixers 304 and 305 by using the local oscillation signal output from the local oscillator 307. The resultant reception signals are converted into reception signals in the baseband and input to the baseband amplifiers 308 and 309. The reception signals amplified by the baseband amplifiers 308 and 309 are detected by the phase detector 312 through the low-pass filters 310 and 311 and input to the voice amplifier 313.

In this case, the frequency of the local oscillation signal used by each of the mixers 304 and 305 to perform frequency conversion is set to the same frequency as that of the reception signal which is multiplied by n. The frequency of the reception signal received by the antenna 301 is therefore different from the frequency of the local oscillator 307. Part of the local oscillation signal mixes in from each of the mixers 304 and 305 to the antenna 301. However, since the frequency of the reception signal is different from that of the local oscillation signal, the frequency band of the local oscillation signal becomes a rejection band for the LNA 302 and antenna 301, and the signal is attenuated in the LNA 302 and antenna 301. This makes it possible to suppress the power of a secondary emission signal.

As another conventional receiver, the receiver based on the direct conversion scheme like the one shown in FIG. 2 is also known. The operation of this conventional receiver will be described below with reference to FIG. 2. The receiver shown in FIG. 2 is comprised of an antenna 401, antenna duplexer 402, switches 403 and 405, LNA 404, high-frequency filter 406, mixers 407 and 408, phase shifter 409, local oscillator 410, baseband amplifiers 411 and 412, low-pass filters 413 and 414, and baseband signal processing section 415. The respective constituent elements are connected as shown in FIG. 2.

Referring to FIG. 2, the reception signal received by the antenna 401 is input to the switch 403 through the antenna duplexer 402. The switches 403 and 405 switch routes for processing the reception signal in accordance with the reception power of the reception signal. More specifically, if the reception power is low, the route on the LNA 404 side is selected, whereas if the reception power is high, the route bypassing the LNA 404 is selected. The LNA 404 is bypassed by using the switches 403 and 405 in order to prevent the mixers 407 and 408 arranged on the output stage of the LNA 404 from being saturated when the power of an input reception signal increases.

The reception signal output from the switch 405, which passes through different routes in accordance with the reception power, is input to the mixers 407 and 408 through the high-frequency filter 406. Each of the mixers 407 and 408 performs quadrature demodulation of the input reception signal by using the local oscillation signal output from the local oscillator 410, and directly frequency-converts the reception signal into a reception signal in the baseband. The reception signals frequency-converted into the reception signals in the baseband are amplified by the baseband amplifiers 411 and 412. The amplified signals are then input to the baseband signal processing section 415 through the low-pass filters 413 and 414.

The conventional receiver shown in FIG. 2 uses a method of attenuating the power of a secondary emission signal that mixes in from the local oscillation signal by using reverse isolation in the LNA 404.

In the conventional receiver shown in FIG. 1, the multiplier 303 can be easily implemented as long as the reception frequency is about 280 MHz. In recent radio communication, however, the reception frequency is about 800 MHz or more or about 2 GHz, and hence the multiplier 303 is difficult to implement. In addition, it is difficult to implement the local oscillator 307 for oscillating a local oscillation signal.

In another conventional receiver shown in FIG. 2, as the input power increases, the switches 403 and 405 select the route bypassing the LNA 404 in order to prevent the mixers 407 and 408 from being saturated. For this reason, no reverse isolation can be obtained in the LNA 404, and the power of a secondary emission signal cannot be suppressed.

### SUMMARY OF THE INVENTION

The present invention has been made to solve the above problems in the related art, and has as its object to provide a receiver using a direct conversion scheme which can suppress saturation of a mixer provided on the output side even if reception power becomes a strong electric field, and can also suppress the power of a secondary emission signal originating from mixing in of a local oscillation signal.

In order to achieve the above object, according to the first aspect of the present invention, there is provided a direct conversion receiver for amplifying a high-frequency reception signal from an antenna and converting the amplified output into a baseband signal by using a mixer, comprising a variable attenuator provided on an input side of the mixer, and control means for comparing an antenna reception power with a first threshold and controlling an attenuation amount of the attenuator on the basis of the comparison result.

According to the second aspect of the present invention, there is provided a direct conversion receiver in which the control means in the first aspect increases the attenuation amount of the attenuator if the antenna reception power is higher than the first threshold.

According to the third aspect of the present invention, there is provided a direct conversion receiver for amplifying a high-frequency reception signal from an antenna by using an amplifier and converting the amplification output into a baseband signal by using a mixer, comprising an attenuator provided in parallel with the amplifier, and switching control means for comparing an antenna reception power with a first threshold and controlling switching between a route through the attenuator and a route through the amplifier on the basis of the comparison result.

According to the fourth aspect of the present invention, there is provided a direct conversion receiver in which the control means in the third aspect switches to the route through the attenuator if the antenna reception power is higher than the first threshold.

According to the fifth aspect of the present invention, there is provided a direct conversion receiver which is the direct conversion receiver described in one of the first to fourth aspects and further comprises a baseband amplifier for amplifying the baseband signal, means for calculating the reception power on the basis of a level of the amplification output, and means for comparing the reception power calculation result with a second threshold and controlling a gain of the baseband amplifier in accordance with the comparison result.

According to the sixth aspect of the present invention, there is provided a direct conversion receiver in which the control means in the fifth aspect comprises means for calculating the antenna reception power by using a gain of components from the antenna to an input terminal of the baseband amplifier, the reception power calculation result, and a gain controlled variable of the baseband amplifier, and comparison means for comparing the calculation output with the first threshold.

As described above, in the direct conversion receiver according to the present invention, when a variable attenuator is provided on the front end portion and the receiver receives a signal with a strong electric field, control is made to increase the attenuation amount of the variable attenuator, and the attenuation amount and reverse isolation at the front end portion are ensured in the variable attenuator, thereby preventing sensitivity drop due to saturation of the mixer. In addition, the power of a secondary emission signal produced when part of a local oscillation signal used for frequency conversion in the mixer mixes in from the mixer to the antenna is also suppressed.

When a route through an attenuator is provided on the front end portion of the direct conversion receiver in parallel with a route through a low-noise amplifier, and the receiver receives a signal with a strong electric field, the same function and effect as those described above can be obtained by making control to select the route through the attenuator.

As described above, according to the present invention, when a variable attenuator is provided on the front end of the receiver, and the receiver receives a reception with a strong electric field, sensitivity drop due to saturation of the mixer can be prevented by increasing the attenuation amount of the variable attenuator and the attenuation amount and reverse isolation are ensured at the front end of the receiver. In addition, the power of a secondary emission signal produced when part of a local oscillation signal used for frequency conversion in the mixer mixes in from the mixer to the antenna is also suppressed.

According to the present invention, a switch and attenuator are arranged on the front end of the receiver to allow selection between the route through the LNA and the route through the attenuator. When a reception signal with strong electric field is received, the switch is operated to select the route on the attenuator side to ensure an attenuation amount and reverse isolation on the front end of the receiver. This makes it possible to prevent sensitivity drop due to saturation of the mixer and suppress the power of a secondary emission signal produced when part of a local oscillation signal used for frequency conversion in the mixer mixes in from the mixer to the antenna is also suppressed.

The above and many other objects, features and advantages of the present invention will become manifest to those skilled in the art upon making reference to the following detailed description and accompanying drawings in which preferred embodiments incorporating the principle of the present invention are shown by way of illustrative examples.

### BRIEF DESCRIPTION OF THE DRAWINGS

FIG. 1 is a block diagram showing the arrangement of an example of a conventional direct conversion receiver;

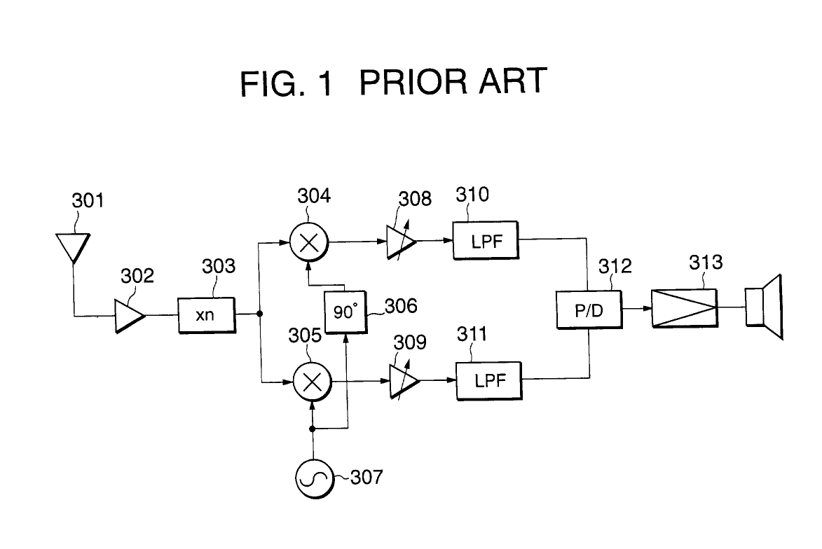

FIG. 2 is a block diagram showing the arrangement of another example of the conventional direct conversion receiver;

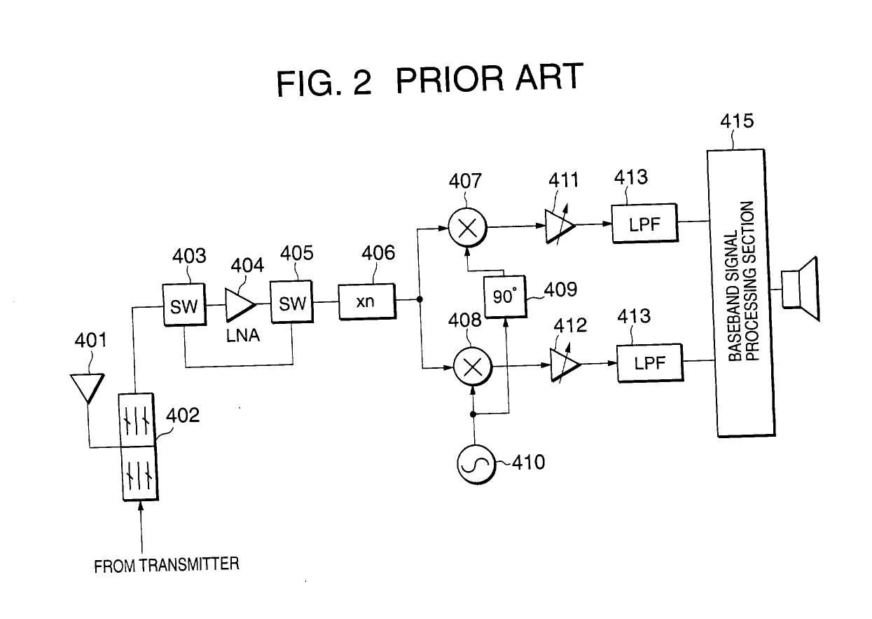

FIG. 3 is a block diagram showing the first embodiment of the present invention;

FIG. 4 is a block diagram showing a specific example of a baseband signal processing section in FIG. 3;

FIG. 5 is a block diagram showing the arrangement of the second embodiment of the present invention; and

FIG. 6 is a block diagram showing a specific example of a baseband signal processing section in FIG. 5.

### DETAILED DESCRIPTION OF THE PREFERRED EMBODIMENTS

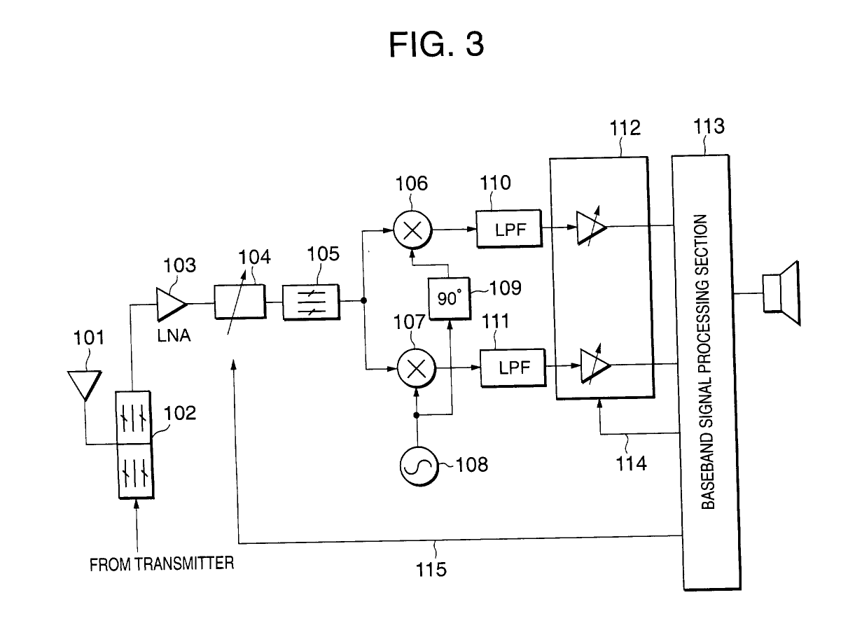

Several preferred embodiments of the present invention will be described below with reference to the accompanying drawings (FIGS. 3 to 6).

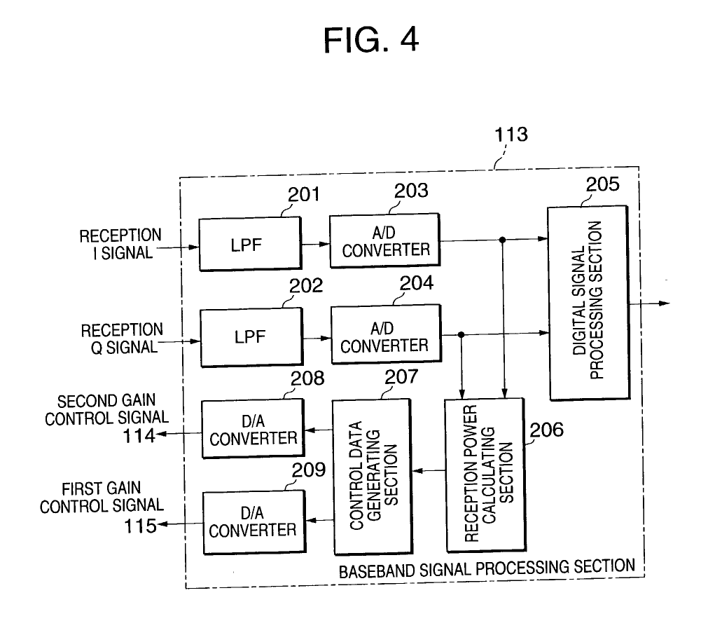

FIG. 3 is a block diagram showing the arrangement of the first embodiment of the present invention. FIG. 4 is a block diagram showing the arrangement of an example of the baseband signal processing section in FIG. 3.

Referring to FIG. 3, a direct conversion receiver according to the present invention is comprised of an antenna 101, antenna duplexer 102, LNA 103, variable attenuator 104, high-frequency filter 105, mixers 106 and 107, local oscillator 108, phase shifter 109, low-pass filters 110 and 111, baseband amplifier 112, and baseband signal processing section 113.

Referring to FIG. 4, the baseband signal processing section 113 is comprised of low-pass filters 201 and 202, A/D converters 203 and 204, digital signal processing section 205, reception power calculating section 206, control data generating section 207, and D/A converters 208 and 209.

As shown in FIGS. 3 and 4, the variable attenuator 104 is provided at the front end of the receiver, and the reception power calculating section 206 and control data generating section 207 are provided for the baseband signal processing section 113 constituting the receiver. In addition, the first threshold (not shown) that is used to control the attenuation amount of the variable attenuator 104 is set in the control data generating section 207 provided for the baseband signal processing section 113 constituting the receiver.

The variable attenuator 104 provided at the front end of the receiver, the reception power calculating section 206 and control data generating section 207 provided for the baseband signal processing section 113 constituting the receiver, and the first threshold set in the control data generating section 207 execute the following operation. The signal transmitted from a base station (not shown) is received by the antenna 101. The reception power calculating section 206 calculates an antenna reception power of the signal received by the antenna 101. The control data generating section 207 calculates the reception power of the signal received by the antenna 101 by using the reception power of the reception signal input from the reception power calculating section 206, the total gain of the components ranging from the antenna 101 to the input terminal of the baseband amplifier 112, and the gain control amount of the baseband amplifier 112, and compares the calculated reception power with the first threshold set in the control data generating section 207. If the reception power of the reception signal is higher than the threshold, the attenuation amount of the variable attenuator 104 is increased.

If the reception power of the signal received by the antenna 101 is a strong electric field, the attenuation amount of the variable attenuator 104 is increased. Even if, therefore, the receiver receives a reception signal with a strong electric field, since the attenuation amount of the variable attenuator 104 is increased, desensitization due to the saturation of the mixers 106 and 107 provided on the output stage of the LNA 103 can be prevented. In addition, as the attenuation amount of the variable attenuator 104 increases, reverse isolation at the front end of the receiver is ensured. This also makes it possible to suppress the power of a secondary emission signal that is produced when part of a local oscillation signal used by the mixers 106 and 107 for frequency conversion of the reception signal.

The first embodiment will be described in detail below.

As is obvious from FIG. 3, this embodiment is comprised of the antenna 101 for receiving the signal transmitted from a base station (not shown), the antenna duplexer 102 for separating signals in the transmission and reception bands, the LNA 103 for amplifying only a signal in the reception band of the radio frequency band, the variable attenuator 104 capable of controlling the attenuation amount, the high-frequency filter 105 for passing only a signal in the reception band of the radio frequency band, the mixers 106 and 107 for frequency-converting a reception signal in the radio band into a reception signal in the baseband, the local oscillator 108 used for frequency conversion, the phase shifter 109 for rotating the phase of a local oscillation signal through 90° for quadrature demodulation, the low-pass filters 110 and 111 which pass only a reception signal in the baseband, the baseband amplifier 112 capable of controlling the gain, and the baseband signal processing section 113 which performs digital signal processing such as error correction and generates control signals for controlling the attenuation amount of the variable attenuator 104 and the gain of the baseband amplifier 112.

The antenna 101 is connected to the transmission/reception input/output terminal of the antenna duplexer 102. The transmission-side input terminal of the antenna duplexer 102 is connected to the output terminal of a transmitter (not shown). The reception-side output terminal of the antenna duplexer 102 is connected to the input terminal of the LNA 103. The output terminal of the LNA 103 is connected to the input terminal of the variable attenuator 104. The control signal input terminal of the variable attenuator 104 is connected to the baseband signal processing section 113 through a first gain control signal 115.

The output terminal of the variable attenuator 104 is connected to the input terminal of the high-frequency filter 105. The output terminal of the high-frequency filter 105 is connected to the radio band signal input terminals of the mixers 106 and 107. The local signal input terminal of the mixer 106 is connected to the output terminal of the phase shifter 109. The input terminal of the phase shifter 109 is connected to the output terminal of the local oscillator 108. The local signal input terminal of the mixer 107 is connected to the output terminal of the local oscillator 108. The baseband signal output terminals of the mixers 106 and 107 are connected to the input terminals of the low-pass filters 110 and 111, respectively. The output terminals of the low-pass filters 110 and 111 are connected to the input terminal of the baseband amplifier 112. The control signal input terminal of the baseband amplifier 112 is connected to the baseband signal processing section 113 through a second gain control signal 114. The output terminal of the baseband amplifier 112 is connected to the input terminal of the baseband signal processing section 113.

The internal arrangement of the baseband signal processing section 113 will be described in detail next with reference to FIG. 4.

The baseband signal processing section 113 shown in FIG. 4 is comprised of the low-pass filters 201 and 202 for removing aliasing distortion from the A/D converters for converting analog signals into digital signals, the A/D converters 203 and 204 for converting analog signals into digital signals, the digital signal processing section 205 for performing digital signal processing such as error correction, the reception power calculating section 206 for calculating the reception power of a reception signal, the control data generating section 207 for generating control signals for controlling the gains of the variable attenuator 104 and baseband amplifier 112, and the D/A converters 208 and 209 for converting digital signals into analog signals.

The output terminal of the baseband amplifier 112 is connected to the input terminals of the low-pass filters 201 and 202 for removing aliasing distortion. The input terminals of the A/D converters 203 and 204 are connected to the output terminals of the low-pass filters 201 and 202, respectively. The output terminals of the A/D converters 203 and 204 are connected to the input terminals of the digital signal processing section 205 and reception power calculating section 206, respectively. The output terminal of the reception power calculating section 206 is connected to the input terminal of the control data generating section 207. The output terminal of the control data generating section 207 is connected to the D/A converters 208 and 209. The output terminal of the D/A converter 208 is connected to the gain control signal input terminal of the baseband amplifier 112 through the second gain control signal 114. The output terminal of the D/A converter 209 is connected to the gain control signal input terminal of the variable attenuator 104 through the first gain control signal 115. In this manner, the direct conversion receiver according to the present invention is formed.

The operation of the first embodiment having the above arrangement will be described below.

The signal transmitted from a base station (not shown) is received by the antenna 101. The signal is then input to the LNA 103 through the antenna duplexer 102. The reception signal amplified by the LNA 103 is input to the variable attenuator 104 and input to the high-frequency filter 105 through the variable attenuator 104.

At first, the attenuation amount of the variable attenuator 104 is set to be minimum. The reception signal that has passed through the high-frequency filter 105 is input to the mixers 106 and 107. The mixers 106 and 107 perform quadrature demodulation by using the local oscillation signal output from the local oscillator 108 and the local oscillation signal obtained by rotating the local oscillation signal output from the local oscillator 108 through 90° by using the phase shifter 109. At the same time, the mixers 106 and 107 directly frequency-convert the reception signals in the radio frequency band into reception signals as I and Q components.

The reception signals as the I and Q components output from the mixers 106 and 107 are input to the baseband amplifier 112 through the low-pass filters 110 and 111. The reception signals amplified by the baseband amplifier 112 are input to the baseband signal processing section 113. The reception signals as the I and Q components input to the baseband signal processing section 113 are input to the A/D converters 203 and 204 through the low-pass filters 201 and 202. The analog signals are then converted into digital signals and input to the digital signal processing section 205 and reception power calculating section 206. The digital signal processing section 205 performs digital signal processing such as error correction for the received signals.

The reception power calculating section 206 calculates reception power within a predetermined time, and outputs the calculation result to the control data generating section 207. The control data generating section 207 generates control signals which consist of digital values and control the attenuation amount of the variable attenuator 104 and the gain of the baseband amplifier 112. The signal for controlling the attenuation amount of the variable attenuator 104 is output to the D/A converter 209, whereas the signal for controlling the gain of the baseband amplifier 112 is output to the D/A converter 208.

The D/A converters 208 and 209 convert the input digital signals into analog signals and output them as the first and second gain control signals 115 and 114 to the variable attenuator 104 and baseband amplifier 112.

A method of controlling the attenuation amount of the variable attenuator 104 and the gain of the baseband amplifier 112 will be described next.

The attenuation amount of the variable attenuator 104 is set to be minimum, and the initial gain of the baseband amplifier 112 is set to be maximum. The first threshold for controlling the attenuation amount of the variable attenuator 104 and the second threshold for controlling the gain of the baseband amplifier 112 are stored in the control data generating section 207.

The first threshold is a value that is set in advance to prevent the mixers 106 and 107 provided on the output stage of the LNA 103 from being saturated with respect to reception signals with strong electric fields. The second threshold is a value that is set in advance to keep the power of reception signals input to the A/D converters 203 and 204 constant.

When the antenna 101 receives the signal transmitted from a base station (not shown), the receiver executes control on the gain of the baseband amplifier 112 first. The gain of the baseband amplifier 112 is controlled by the method of keeping the power of reception signals input to the A/D converters 203 and 204 constant. The control data generating section 207 compares the calculation result on the reception power input from the reception power calculating section 206 with the second threshold stored in the control data generating section 207. If the reception power is higher than the second threshold, the control data generating section 207 generates a control signal consisting of a digital value which decreases the gain of the baseband amplifier 112. If the reception power is lower than the second threshold, the control data generating section 207 generates a control signal consisting of a digital value which increases the gain of the baseband amplifier 112.

The digital control signal generated by the control data generating section 207 is input to the D/A converter 208 to be converted from the digital value into an analog value and is input as the second gain control signal 114 to the baseband amplifier 112. In this manner, the gain of the baseband amplifier 112 is controlled. Subsequently, the receiver controls the gain of the baseband amplifier 112 by periodically repeating the above control processing

A method of controlling the attenuation amount of the variable attenuator 104 will be described next.

In the receiver, the total gain of components ranging the antenna 101 to the input terminal of the baseband amplifier 112 is known, and the control data generating section 207 calculates the power of the reception signal received by the antenna 101 from the calculation result on the reception power input from the reception power calculating section 206, the gain controlled variable of the baseband amplifier 112, and the above total gain. Letting G1 be the total gain of the components ranging from the antenna 101 to the input terminal of the baseband amplifier 112, G2 be the gain of the baseband amplifier 112, and P1 be the power at the input terminals of the A/D converters 203 and 204, the total reception power at the antenna 101 is given by the following equation (1).

Total reception power=(P1−G2)−G1 (1)

Note that the gain G2 can be calculated from the difference between the previous gain controlled variable of the baseband amplifier and the current gain controlled variable of the baseband amplifier. The control data generating section 207 compares the calculation result on the reception power of the reception signal received by the antenna 101 and the first threshold stored in the control data generating section 207.

If the calculated reception power is lower than the first threshold, since the calculated reception power is not power that makes the mixers 106 and 107 arranged on the output side of the LNA 103 become saturated, the attenuation amount of the variable attenuator 104 is not controlled. The digital control signal generated to control the attenuation amount of the variable attenuator 104 becomes a control signal that, sets the attenuation amount of the variable attenuator 104 to a minimum value.

If the calculated reception power is higher than the first threshold, the control data generating section 207 generates a digital control signal that increases the attenuation amount of the variable attenuator 104 in order to prevent the mixers 106 and 107 arranged on the output side of the LNA 103 from being saturated. The generated digital control signal is input to the D/A converter 209 and converted from the digital value into an analog value, which is input as the first gain control signal 115 to the variable attenuator 104. In this manner, the attenuation amount of the variable attenuator 104 is controlled.

Note that the variable attenuator 104 serves to prevent the mixers 106 and 107 from being saturated when signals with strong electric fields are input, and hence may be provided on the front ends on the output side of the mixers 106 and 107.

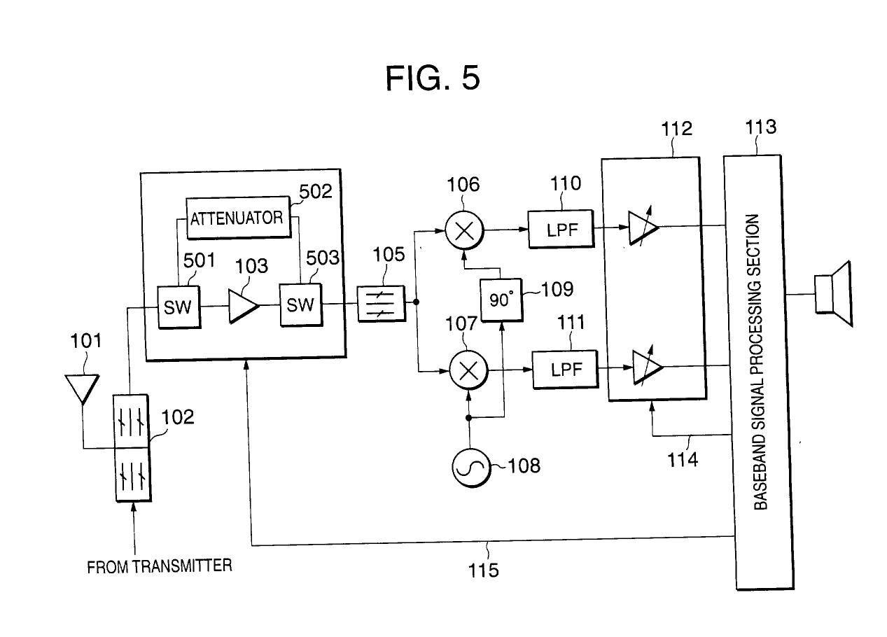

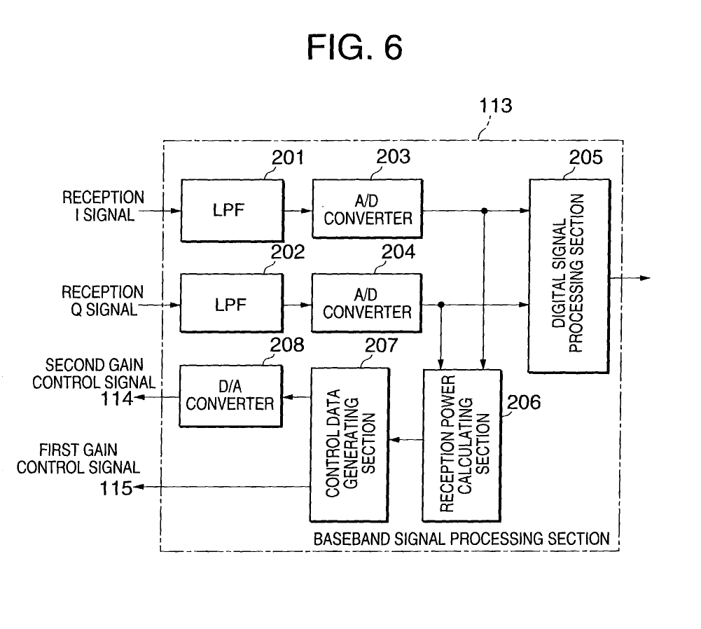

FIG. 5 shows the arrangement of the second embodiment of the direct conversion receiver according to the present invention. The basic arrangement of the second embodiment is the same as that of the first embodiment except that the front end portion as a part of the direct conversion receiver is further contrived. FIG. 6 shows the specific arrangement of the baseband signal processing section 113 in FIG. 5. The arrangement of the second embodiment shown in FIG. 5 differs from the arrangement of the first embodiment shown in FIG. 3 in that switches 501 and 503 and attenuator 502 are arranged at the front end of the receiver, the switch 501 is placed between an antenna duplexer 102 and an LNA 103, the switch 503 is placed between the LNA 103 and a high-frequency filter 105, and the attenuator 502 is placed between the switch 501 and the switch 503. This arrangement allows selection between the route to the LNA 103 and the route to the attenuator 502.

The difference between the baseband signal processing sections 113 in the first and second embodiments respectively shown in FIGS. 4 and 6 is that the D/A converter 209 provided for the baseband signal processing section 113 shown in FIG. 4 is omitted from the baseband signal processing section 113 in the second embodiment shown in FIG. 6.

The operation of the second embodiment shown in FIGS. 5 and 6 will be described next.

The signal transmitted from a base station (not shown) is received by an antenna 101. The reception signal received by the antenna 101 passes through the antenna duplexer 102 and is input to the switch 501.

The switches 501 and 503 are set to make the reception signal pass along the route on the LNA 103 side. The reception signal that has passed through the switch 501 is amplified by the LNA 103 and passes through the high-frequency filter 105 through the switch 503. The resultant signals are then input to mixers 106 and 107.

The mixers 106 and 107 perform quadrature demodulation of the reception signals by using the local oscillation signal output from a local oscillator 108 and the local oscillation signal obtained by rotating the local oscillation signal output from the local oscillator 108 through 90° by using a phase shifter 109. At the same time, the mixers 106 and 107 directly frequency-convert the reception signals in the radio frequency band into reception signals in the baseband and output them as reception signals as I and Q components. The reception signals as the I and Q components output from the mixers 106 and 107 are input to a baseband amplifier 112 through low-pass filters 110 and 111. The reception signals amplified by the baseband amplifier 112 are input to a baseband signal processing section 113.

The reception signals as the I and Q components input to the baseband signal processing section 113 are input to A/D converters 203 and 204 through low-pass filters 201 and 202, respectively. These signals are converted from the analog signals into digital signals and are input to a digital signal processing section 205 and reception power calculating section 206. The digital signal processing section 205 performs digital signal processing such as error correction for the received signals.

The reception power calculating section 206 calculates the reception power within a predetermined time and outputs the calculation result to a control data generating section 207. The control data generating section 207 generates a control signal for selecting one of the routes formed by the switches 501 and 503 and a digital control signal for controlling the gain of the baseband amplifier 112. The control signal for selecting one of the routes formed by the switches 501 and 503 is directly input as a first gain control signal 115 from the control data generating section 207 to the switches 501 and 503. The digital control signal for controlling the gain of the baseband amplifier 112 is -input as a second gain control signal 114 to the baseband amplifier 112 through the D/A converter 208.

A method of controlling the switches 501 and 503 and a method of controlling the gain of the baseband amplifier in the second embodiment will be described next.

The switches 501 and 503 are initially set to select the route on the LNA 103 side, and the initial gain of the baseband amplifier 112 is set to a maximum value.

The first threshold for switching between the routes through the switches 501 and 503 and the second threshold for controlling the gain of the baseband amplifier 112 are stored in the control data generating section 207. The first threshold is a value that is set in advance to prevent the mixers 106 and 107 provided on the output stage of the LNA 103 from being saturated with respect to reception signals with strong electric fields. The second threshold is a value that is set in advance to keep the power of reception signals input to the A/D converters 203 and 204 constant.

When the antenna 101 receives the signal transmitted from a base station (not shown), the receiver executes control on the gain of the baseband amplifier 112 first. The gain of the baseband amplifier 112 is controlled by the method of keeping the power of reception signals input to the A/D converters 203 and 204 constant. The control data generating section 207 compares the calculation result on the reception power input from the reception power calculating section 206 with the second threshold stored in the control data generating section 207. If the reception power is higher than the second threshold, the control data generating section 207 generates a control signal consisting of a digital value which decreases the gain of the baseband amplifier 112. If the reception power is lower than the second threshold, the control data generating section 207 generates a control signal consisting of a digital value which increases the gain of the baseband amplifier 112.

The digital control signal generated by the control data generating section 207 is input to the D/A converter 208 to be converted from the digital value into an analog value and is input as the second gain control signal 114 to the baseband amplifier 112. In this manner, the gain of the baseband amplifier 112 is controlled. Subsequently, the receiver controls the gain of the baseband amplifier 112 by periodically repeating the above control processing.

A method of controlling switching between the routes through the switches 501 and 503 will be described next.

In the receiver, the total gain of the components ranging from the antenna 101 to the input terminal of the baseband amplifier 112 is known, and the control data generating section 207 calculates the reception power of the signal received by the antenna 101 by using equation (1) from the calculation result on the reception power input from the reception power calculating section 206, the gain controlled variable of the baseband amplifier 112, and the above total gain. The control data generating section 207 compares the calculation result on the reception power of the reception signal received by the antenna 101 with the first threshold stored in the control data generating section 207.

If the reception power is lower than the first threshold, since the calculated reception power is not power that makes the mixers 106 and 107 arranged on the output side of the LNA 103 become saturated, switching between the routes through the switches 501 and 503 is not controlled. That is, the control data generating section 207 generates a control signal for selecting the route on the LNA 103 side.

If the reception power is higher than the first threshold, the control data generating section 207 generates a control signal for selecting the route on the attenuator 502 side to prevent the mixers 106 and 107 arranged on the output side of the LNA 103 from being saturated. The control signal generated by the control data generating section 207 is input as the first gain control signal 115 to the switches 501 and 503. As a consequence, switching between the routes through the switches 501 and 503 is controlled, and the route through the LNA 103 or the route through the attenuator 502 is selected in accordance with the reception power of the signal received by the antenna 101.

As described above, according to the second embodiment of the present invention, the route passing through the LNA 103 and the route passing through the attenuator 502 are arranged on the front end of the receiver, and the receiver operates upon selection of the route through the LNA 103 or the route through the attenuator 502 in accordance with the reception power of the signal received by the antenna 101. Even if, therefore, the antenna 101 receives a reception signal with strong electric field, saturation of the mixers 106 and 107 arranged on the output side of the LNA 103 can be prevented by selecting the route on the attenuator 502 side. In addition, by selecting the route on the attenuator 502 side, reverse isolation can be ensured, and hence the power of a secondary emission signal that is produced when part of a local oscillation signal mixes in can be suppressed.

This is because, a route can be selected in accordance with the reception power of the signal received by the antenna 101 by using the switches 501 and 503 which are arranged on the front end of the receiver to allow selection of the route on the LNA 103 side or the route on the attenuator 502 side. In addition, the reception power of the reception signal received by the antenna 101 is calculated on the basis of the reception power calculated by the reception power calculating section 206 in the baseband signal processing section 113, the gain controlled variable of the baseband amplifier 112, and the total gain of the components ranging from the antenna 101 to the input terminal of the baseband amplifier 112, and the calculated reception power can be compared with the first threshold stored in the control data generating section 207 in the baseband signal processing section 113.

If the power of the reception signal is higher than the first threshold, the switches 501 and 503 are controlled to select the route through the attenuator 502.

As a consequence, if the receiver receives a reception signal with strong electric field, the route through the attenuator 502 is selected. This increases the attenuation amount on the front end of the receiver and reverse isolation on the front end of the receiver.

What is claimed is:

1. A direct conversion receiver for amplifying a high-frequency reception signal from an antenna and converting the amplified output into a baseband signal by using a mixer, comprising a variable attenuator provided on an input side of said mixer, and control means for comparing an antenna reception power with a first threshold and controlling an attenuation amount of said attenuator on the basis of the comparison result.

2. A receiver according to claim 1, wherein said control means increases the attenuation amount of said attenuator if the antenna reception power is higher than the first threshold.

3. A direct conversion receiver for amplifying a high-frequency reception signal from an antenna by using an amplifier and converting the amplification output into a baseband signal by using a mixer, comprising an attenuator provided in parallel with said amplifier, and a switching control means for comparing an antenna reception power with a first threshold and controlling switching between a route through said attenuator and a route through said amplifier on the basis of the comparison result.

4. A receiver according to claim 3, wherein said control means switches to the route through said attenuator if the antenna reception power is higher than the first threshold.

5. A receiver according to claim 1, further comprising a baseband amplifier for amplifying the baseband signal, means for calculating the reception power on the basis of a level of the amplification output, and means for comparing the reception power calculation result with a second threshold and controlling a gain of said baseband amplifier in accordance with the comparison result.

6. A receiver according to claim 3, further comprising a baseband amplifier for amplifying the baseband signal, means for calculating the reception power on the basis of a level of the amplification output, and means for comparing the reception power calculation result with a second threshold and controlling a gain of said baseband amplifier in accordance with the comparison result.

7. A receiver according to claim 5, wherein said control means comprises means for calculating the antenna reception power by using a gain of components from said antenna to an input terminal of said baseband amplifier, the reception power calculation result, and a gain controlled variable of said baseband amplifier, and comparison means for comparing the calculation output with the first threshold.

8. A receiver according to claim 6, wherein said control means comprises means for calculating the antenna reception power by using a gain of components from said antenna to an input terminal of said baseband amplifier, the reception power calculation result, and a gain controlled variable of said baseband amplifier, and comparison means for comparing the calculation output with the first threshold.
